(19) United States
(12) Patent Application Publication
(10) Pub. No.: US 2006/0142985 A1
(43) Pub. Date: Jun. 29, 2006

(54) Modelling system

(76) Inventors: Paul O'Donnell, Castlebar (IE); Liam Gerald Morris, Galway (IE); Timothy Mary McGloughlin, Ballyclough (IE)

Correspondence Address: JACOBSON HOLMAN PLLC, 400 SEVENTH STREET N.W., SUITE 600, WASHINGTON, DC, 20004, US

(21) Appl. No.: 11/283,845

(22) Filed: Nov. 22, 2005

Related U.S. Application Data
(60) Provisional application No. 60/642,981, filed on Jan. 12, 2005.

(30) Foreign Application Priority Data
Nov. 22, 2004 (IE) 2004/0779

(51) Int. Cl. G06G 7/48; G06G 7/58

(52) U.S. Cl. 703/11

(57) ABSTRACT

A modelling system (1) comprises a blood vessel simulating model (2) connected to a pump system (3) and mounted in the field of view of a polariscope system (4) and a camera system (7). The model (2) is mounted on an adjustable stand (5). The blood vessel simulating model (2) is connected to the pump system by outlet control and access valves (10). The blood vessel simulating model (2) is connected to the pump system (3) by a clip (9). A pressure sensor (8) is provided to monitor pressure levels within the model (2). The pump system (3), pressure sensor (8), polariscope (4) and camera (7) are controlled by controllers (39, 11, 13). The adjustable stand (5) is movable to facilitate rotation, change of orientation, change of level of one end of the model with respect to the other end, and bending of the blood vessel simulating model (2). The pump system (3) circulates a liquid to the model (2) to simulate blood flow in the model. The modelling system (1) facilitates determination of the magnitude and direction of the resultant pulsative forces acting on the model (2).

### INTRODUCTION

The invention relates to a modelling system and in particular a blood vessel simulation modelling system.

In one current approach the pressures which act on a blood vessel wall as a result of the pulsative forces of the heart are modelled using one or more strain gauges. A strain gauge is mounted on the wall of a latex model of the vessel [Reference 7]. The vessel model is connected to a pump which simulates the action of the heart. However, this approach is limited since the strain is measured only at the point at which the gauge is attached and also mounting the gauge on the model wall directly affects the strain experienced at that point. In another approach a model is provided to enable training on techniques for implanting a medical device, for example, a stent into a blood vessel. The model may be manufactured of glass, silicone or latex and users practice inserting the implant through an opening in the model wall. However, this approach is of limited use in showing the effects of the implant on the vessel and the forces introduced into the vessel as a result of the implant. In other approaches measurements have been made using a video extensometer [References 1, 2, 3], photonic sensors [Reference 4], a photocell combined with light emitting diode [References 5, 6], or scanning laser. In a further approach computational modelling by Finite Element Analysis is used to model the theoretical effects of the forces which act on a blood vessel wall as a result of forces of the heart and/or the introduction of an implant into a vessel. Another approach is to bench test an implant. This involves using tensile, compression and torsion equipment to measure the radial forces produced by the implant, and the stiffness, torqueability and tensile/compressive properties of the implant. The above methods are of limited value. Thus there is a need for an improved blood vessel simulation modelling system.

### REFERENCES

1. Ling, S. C. and Atabek, H. B. (1972). A nonlinear analysis of pulsatile flow in arteries. Journal of Fluid Mechanics. 55(3), 493-511.
2. Liepsh, D. and Zimmer, R. (1995). The dynamics of pulsatile flow in distensible model arteries. Technology and Health Care. 3, 185-199.
3. Elad, D., Sahar, M., Avidar, J. M. and Einav, S. (1992). Steady flow through collapsible tubes: Measurements of flow and geometry. Journal of Biomechanical Engineering. 114, 84-91.
4. Van Steenhoven, A. A. and Van Dongen, M. E. H. (1986). Model studies of the aortic pressure rise just after valve closure. Journal of Fluid Mechanics. 166, 93-113.
5. Hayashi, K., Sato, M., Handa, H. and Moritake, K. (1974). Biomechanical study of the constitutive laws of vascular walls. Experimental Mechanics. 14, 440-444.
6. Papageorgiou, G. L. and Jones, N. B. (1988). Circumferential and longitudinal iscoelasticity of human iliac arterial segments in vitro. Journal of Biomedical Engineering. 10, 82-90.
7. Cadiovascular flow modelling and measurement with application to clinical medicine. Clarenden Press Oxford, 1999. edited by S. C. Sajjadi, G. B. Nash, M. W. Rampling.

### SUMMARY OF THE INVENTION

According to the invention there is provided a system for modelling forces and/or stresses and/or strains exerted on a body part, the system comprising:
a body part simulator configured with characteristics substantially similar to a body part being simulated;
the body part simulator comprising a photoelastic material;
an optical measuring system for optically measuring forces and/or stresses and/or strains exerted on the body part simulator;
the measuring system comprising a polariscope.

In one embodiment, an inner surface of the body part simulator is bonded using a reflective adhesive to an inner surface liner comprised of a plastics, rubber or polymer material in a tri-layer configuration.

In one embodiment, the body part simulator is formed by injection moulding.

In another embodiment, the body part simulator is formed by casting.

In another embodiment, the body part simulator comprises a plastics or rubber or polymer material.

In another embodiment, the photoelastic material has a modulus of greater than 0.4 MPa.

In another embodiment, the photoelastic material has a modulus in the range of from 0.5 MPa to 2900 MPa.

In another embodiment, an inner surface of the body part simulator is coated with a reflective adhesive.

In another embodiment, the body part simulator is mounted on an adjustable support.

In another embodiment, the support is adjustable to adjust the orientation of the body part simulator to a desired angle for modelling of forces and/or stresses and/or strains exerted on the body part simulator at different body postures, such as upright, sitting, lying down.

In another embodiment, the body part simulator comprises an abnormality simulator portion configured to simulate an abnormality, such as an aneurysm or stenosis.

In one embodiment, an implant is insertable into the body part simulator to model forces and/or stresses and/or strains resulting from insertion of the implant.

In another embodiment, the system comprises an implant insertable into the body part simulator. The implant may be a stent, or stent graft, or filter, or sensor, or angioplasty catheter, or delivery catheter, or delivery system, or retrieval catheter.

In another embodiment, the body part simulator comprises a blood vessel simulator configured with characteristics substantially similar to a blood vessel being simulated.

In another embodiment, the body part simulator comprises a hollow vessel simulator of the urinary system configured with characteristics substantially similar to the hollow vessel being simulated.

In another embodiment, the body part simulator comprises a hollow vessel simulator of the digestive system configured with characteristics substantially similar to the hollow vessel being simulated.

In another embodiment, the body part simulator comprises a hollow vessel simulator of the reproductive system configured with characteristics substantially similar to the hollow vessel being simulated.

In another embodiment, the body part simulator comprises a hollow vessel simulator of the respiratory system configured with characteristics substantially similar to the hollow vessel being simulated.

In another embodiment, the system comprises a body fluid simulator in fluid communication with the body part simulator.

In another embodiment, the body fluid simulator comprises a blood simulator.

In another embodiment, the system comprises a fluid circulation system for circulating the body fluid simulator.

In another embodiment, the fluid circulation system comprises a pump, a fluid reservoir, and a controller.

In another embodiment, the body part simulator is connected in fluid communication with the fluid circulation system by one or more valve connectors.

In another embodiment, the optical measuring system comprises a video and/or a still camera.

In another aspect, the invention provides a modelling system comprising a blood vessel simulating model connected to a blood flow simulation system for modelling the forces and/or stresses and/or strains of blood flow and blood pressure on the blood vessel.

In another aspect, the invention provides a method of modelling the stresses and strains of pulsative forces on a blood vessel comprising the steps of:
manufacturing a blood vessel simulating model according to specifications of the vessel to be simulated;
mounting the model in a modelling system on an adjustable stand and connected to a liquid circulation system;
circulating liquid into the model;
varying the pressure exerted on the model by the liquid;
varying the orientation of the model; and
acquiring stress and strain data of the model under different pressure and at different orientations using a polariscope system.

### BRIEF DESCRIPTION OF THE DRAWINGS

The invention will be more clearly understood from the following description thereof given by way of example only with reference to the accompanying drawings in which:

FIG. 1 is a diagram illustrating the main components of a modelling system of the invention;

FIG. 2 is an illustration of an inner core model mould according to the invention;

FIG. 3 is a perspective view of the inner core model mould of FIG. 2;

FIG. 4 is a perspective view of an inner core model in position in an outer half of an injection mould for moulding a model of the invention;

FIG. 5 is an illustration of an injection moulded model with the inner core model in place;

FIG. 6 is an illustration of an injection moulded model according to the invention;

FIG. 7 is a view of the model of FIG. 6 connected in the modelling system;

FIGS. 8 and 9 are detailed views of the access valve connector of FIG. 7;

FIG. 10 is an illustration of a model of the invention the testing of which and some results of testing are illustrated in FIGS. 11 to 28, and the model shown is of an Abdominal Aorta Aneurysm;

FIG. 11 is an enlarged image of a proximal photostress pattern of the model of FIG. 10 under pressure;

FIG. 12 is an enlarged full field image of a null balance compensation of the green-yellow fringe of FIG. 10;

FIG. 13 is an enlarged full field image of a distal photostress pattern of the model of FIG. 10;

FIG. 14 is a diagram illustrating the circumferential measurement points of the model of FIG. 10;

FIG. 15 is a graph illustrating the % strain versus orientation at selected points of interest on the proximal and distal iliac sides of the model of FIG. 10;

FIG. 16 is a graph illustrating the % stress versus orientation at selected points of interest on the proximal and distal iliac sides of the model of FIG. 10;

FIG. 17 is a graph illustrating the variation of strain with pressure at selected points of interest of the model of FIG. 10;

FIG. 18 is a graph illustrating stress versus strain with pressure at selected points of interest of the model of FIG. 10 with pressure varying in the range of 200 to zero mmHg in steps of 20 mmHg;

FIGS. 19 and 20 are images of a model according to the invention showing points of rupture of the model wall under pressure;

FIGS. 21 to 26 are illustrations of different orientations of the model of FIG. 10 for testing;

FIG. 27a is an enlarged full field image acquired by a polariscope of the model of FIG. 10 illustrating full field stress/strain distribution under internal forces; FIG. 27b is an illustration of the image of FIG. 27a; and

FIG. 28a is an enlarged image showing isochromatic fringes proximal to the aneurysm sac of the model of FIG. 10; FIG. 28b is an illustration of the image of FIG. 28a.

### DETAILED DESCRIPTION

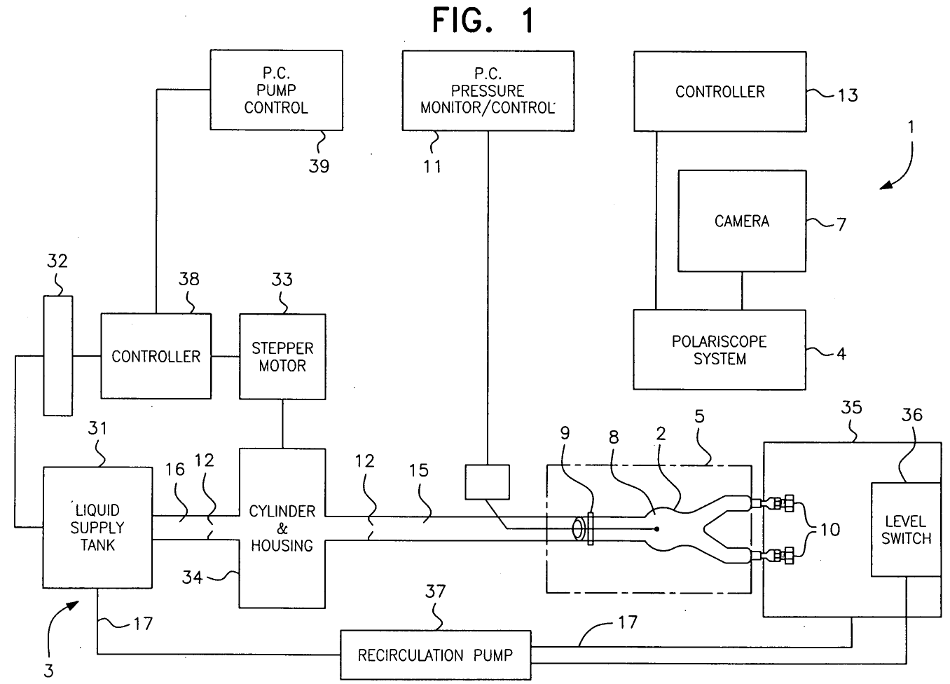

Referring to FIG. 1, the modelling system 1 of the invention comprises a blood vessel simulating model 2 connected to a pump system 3 and mounted in the field of view of a polariscope system 4 and a camera system 7. The model 2 is mounted on an adjustable stand 5. The blood vessel simulating model 2 is connected to the pump system 3 and outlet control and access valves 10. The blood vessel simulating model 2 is connected to the pump system 3 by a clip 9. A pressure sensor 8 is provided to monitor pressure levels within the model 2. The pump system 3, pressure sensor 8 and polariscope 4 and camera 7 are controlled by controllers 39 and 11 and 13 respectively. Of course it will be appreciated that each of the functions could be controlled by a single controller. The camera system 7 comprises a still image and a video camera. The system can visualise and measure the stresses/strains in the blood vessel walls due to internal and/or external forces using a non-contact optical measurement method.

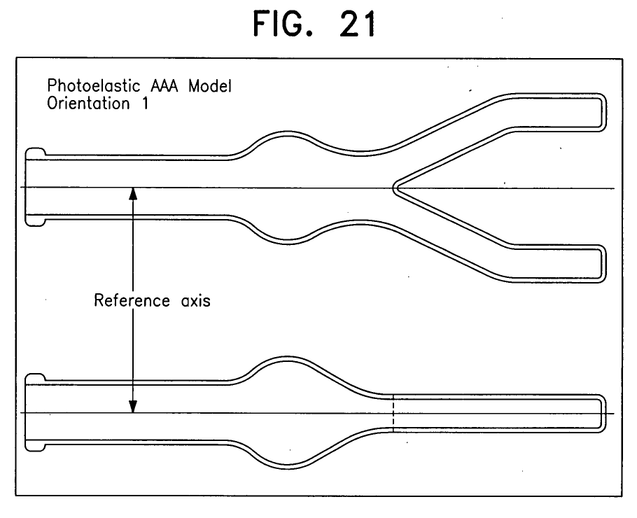

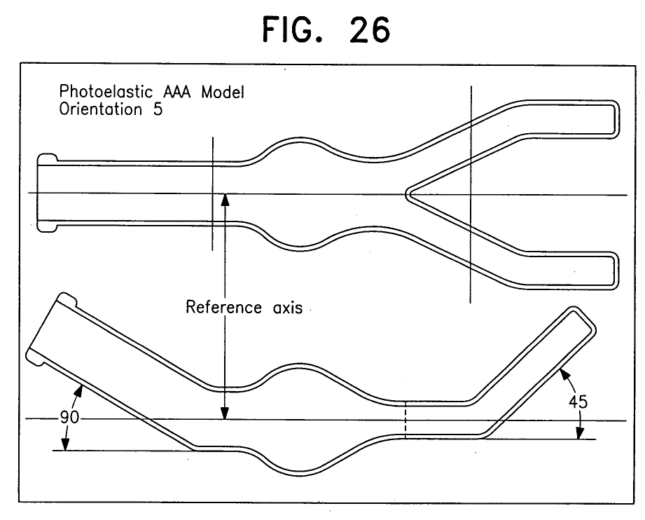

The adjustable stand 5 is movable to facilitate rotation, change of orientation, change of level of one end of the model with respect to the other end, and bending of the blood vessel simulating model 2. The stand 5 thus provides means for simulating the vessel as body posture is changed. Examples of possible orientations are illustrated in FIGS. 21 to 26.

The pump system 3 circulates a liquid to the model 2 to simulate blood flow in the model. The modelling system 1 facilitates determination of the magnitude and direction of the resultant pulsative forces acting on the model 2. Pressures are provided by the pump system 3 to put the model 2 under stress in a way that closely models the stresses experienced in the human body, and the pump 3 replicates the function of the human heart and provides pulsating flow at body temperature which replicates systemic blood pressure in the human body. The pressure level and rate flow of the liquid in the model 2 can be adjusted.

The pump system 3 comprises a liquid supply tank 31 having a temperature controller 32 and a stepper motor 33 connected to a pump cylinder and housing 34 which operates to circulate the liquid from the liquid supply tank 31 via pipes 16, 15 to the model 2. The pipes 16 and 15 comprise non-return valves 12 and the model 2 is connected to the pipe 15 by means of a clip 9, the liquid circulates through the model as required and is returned to a liquid collection tank 35 to which the model is connected by the outlet valves 10, in a first dynamic mode of testing. In a second static mode of testing the outlet valves 10 are closed, and the liquid is retained in the model 2 for the duration of the static tests. Thereafter the valves 10 are opened to allow the liquid to flow out from the model 2. The liquid collection tank 35 is fitted with a level switch 36 and the level switch and liquid collection tank are connected to a re-circulation pump 37 which controls re-circulation of the liquid back to the liquid supply tank 31 via pipes 17. The pump system is controlled by a controller 38 and pump control computer 39.

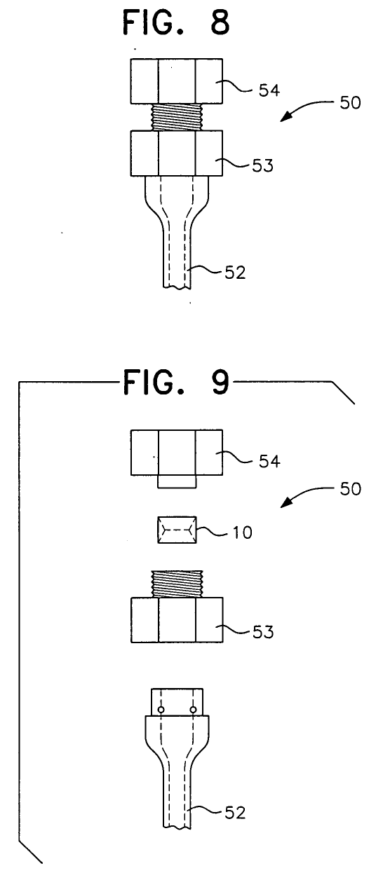

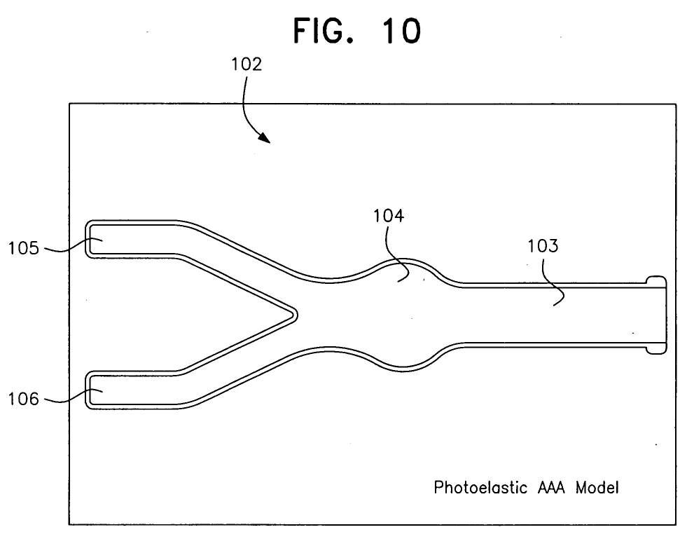

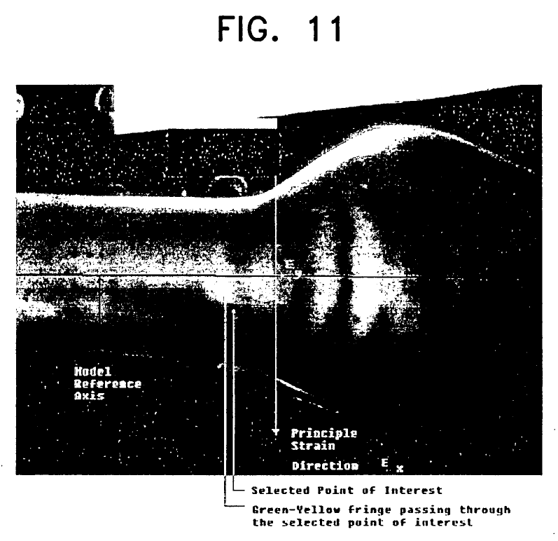

Referring to FIGS. 7, 8 and 9 the outlet access/control valves 10 are illustrated in more detail. The outlet access control valves 10 are connected to the model 2 by means of a valve connector 50 which comprises a tube 51, a funnel connector 52, a threaded valve housing 53, and a threaded valve compression cap 54. The valve 10 is received between the valve housing 53 and the valve compression cap 54. When assembled the valve compression cap 54 may be rotated in the valve housing 53 to cause the valve 10 to be opened or closed as required. The tube 51 as illustrated in FIG. 7 connects the funnel connector 52 to the model 2. The tube 51, funnel 52 and compression cap 54 are manufactured of a plastics material, however, any suitable material may be used.

In monitoring photoelastic material a polariscope system is used to observe the coated component under the applied forces it will experience in actual use. Where a component has a 3-D contoured shape, it is particularly difficult to achieve. The injection molding method of the invention produces a model which is homogeneous and is free from residual stress, with pre-defined wall thicknesses (defined by the moulds). This provides a basis for yielding accurate stress/strain data and accurate interpretation of full field visual information when the model experiences external and/or internal forces.

The photoelastic material is a two-part compound which when mixed produces an exothermic chemical reaction which is of limited duration. The timing, speed and pressure of the injection are important. If the injection is not executed at the correct time the compound rapidly becomes more viscous, injection into thin wall sections will not be possible and residual stress in the 3-D hollow part will possibly result. If the injection is executed too early air pocket formation in the model walls may be an issue.

Coating the core and the cavity with mould release pre-moulding allows the mould to be split and the core removed with ease. If this is not done the model will stick to the mould. However, this is also a common problem when moulding soft polymers such as polyurethane.

An optical measurement system is particularly advantageous for a body part simulator, principally because it is non-contact. i.e. the measurement system does not involve sensors or physical measurement devices which are in direct contact with the body part simulator and as such can in themselves cause an effect on the simulator model.

Reflective adhesive (on the inside of the model) is required to reflect the incident light beams back into the analyser of the polariscope so as to perform the photostress analysis. The reflective adhesive is also used in the coating method to reflect the incident light but also to bond the coating to the component under test so as to transfer the stresses/strains experienced by the component to the coating.

In the current invention the body part simulator is a self supporting entity made from photoelastic materials with dimensional and physical characteristics similar to the body part being simulated.

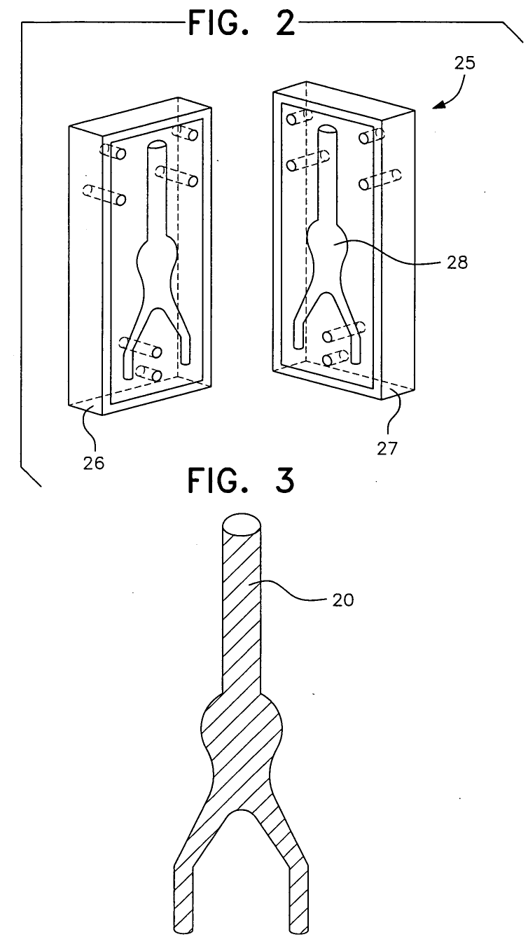

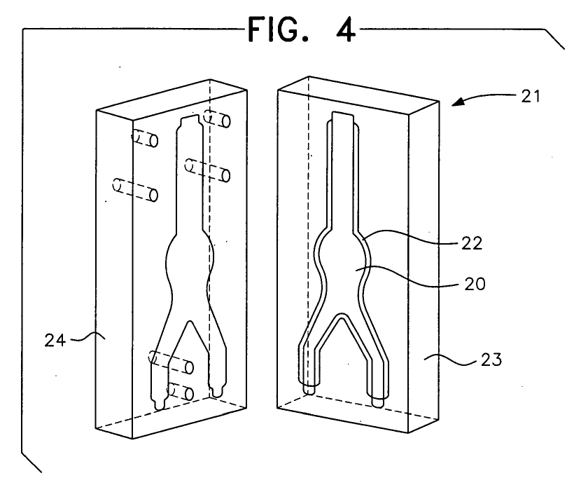

Referring to FIGS. 2, 3, 4 and 5, the manufacture of the blood vessel simulating model 2 is described. The model 2 is formed by injection moulding. A model of any vessel may be formed including normal vessels or vessels with abnormalities for example, including enlarged portions or aneurysms or restricted portions of stenosis.

A model mould 22 comprises a 3-D inner core model 20 which is used to make a uniformly thick 3-D replica model 2 of the vessel, in the embodiment illustrated, a model of an Abdominal Aortic bifurcation is formed. The blood vessel simulating model 2 is manufactured of a photo elastic material, for example PL-3 resin and PLH-3 hardener (from the Measurements Group Inc.) which has similar mechanical properties to the artery itself. It will be appreciated that any suitable material may be used to manufacture the model. The internal surface of the model is coated with a reflective adhesive material for example PC-11 (from the Measurements Group Inc.). PL-3 has a Young's Modulus of 0.014 GPa which was found to be suitable for the present application. Appendix A sets out further details of the materials used.

The manufacture may involve the use of two model moulds namely a model mould 21 and an inner core model mould 25 depending on the complexity of the model required. The model mould 21 comprises a cavity 22 and is provided in two halves 23 and 24. The inner core model mould 25 comprises two halves 26 and 27 and a cavity 28.

If a complex model is required an inner core model 20 is moulded first of all using the inner core model mould 25. The inner core 20 so formed is then used in the moulding process for manufacturing the overall model 2. A complex model is manufactured using the outer mould 21 to injection mould the model 2 with the inner core model 20 being clamped in place if required as the model 2 is moulded. For less complex models only the model mould 21 is required.

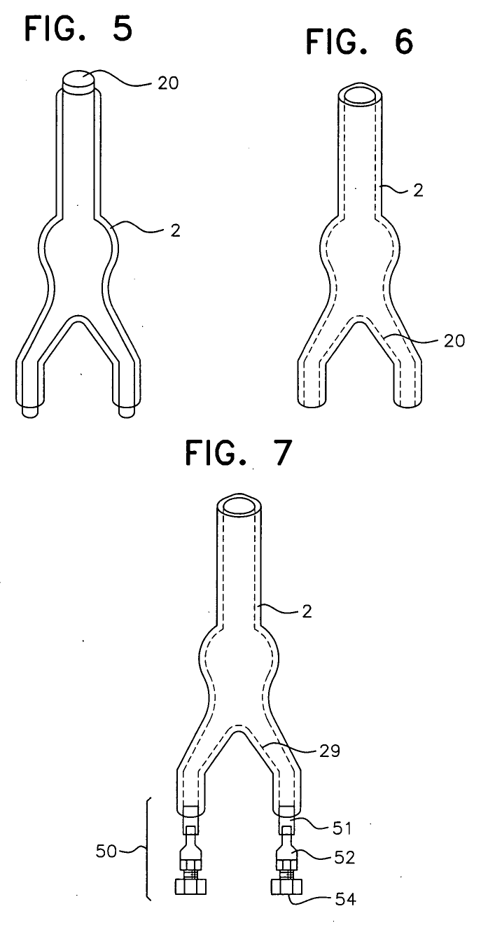

The steps involved in manufacturing a model mould include the following:
1. Drawing the required model in 3D CAD defining all dimensions including wall thickness.
2. Making a metal mould 21 in two halves 23 and 24 to define the outer model dimensions and comprising a mould cavity 22.
3. In the case of complex model shapes (for example Abdominal Aorta Aneurysm (AAA) case), making a metal mould 25 in two halves 26, 27 to produce an inner core model 20 which is a percentage factor smaller that the mould in step 2 above. The model wall thickness is the difference in this case.
4. For less complex models the inner core can be made directly from metal as core pins.
5. The Mould 21 parts 23 and 24 are doweled and clamped for alignment and sealed and have an injection port/point and mould vents at selected points so as to ensure full cavity 22 fill during injection as illustrated in FIG. 5.

The steps of injection moulding inner model core include the following:
1. In the case of complex model shapes (AAA case), an inner model core 20 is injection moulded using for example a 2 part epoxy resin core (ebalta SG700-1) or low melt metal alloy or dissolvable material. The difference between the inner model core 20 and the outer mould cavity 22 is the model wall thickness.
2. The mould release agent used on the mould cavity was for example Ebalta T-1™ which was applied prior to injection.

Injection Moulding the Model includes the steps of:
1. Applying mould release agent to the model inner core 20 and to the cavity of the outer mould 21.
2. Clamping the model inner core 20 into outer model mould 21 and close the mould
3. Preheating the mould 21, injection barrel and plunger/screw to 57 C±2 C
4. Pre mixing the photoelastic material components (resin and hardener) in a heat resistant container using a slow spiral stirring method (to minimise air bubble introduction)
5. The mixing aids an exothermic reaction.
6. Using a thermometer, when 60 C is reached the compound must immediately be transferred to the preheated barrel and injected (via the injection port in the mould) in a slow and controlled manner into the preheated mould.
7. The mould 21 is now placed in an oven for 24 hours at 30 C to cure
8. After curing, the model 2 is split and the model 20 in its inner core is removed.
9. The model 2 is removed and cleaned and the reflective coating is applied to the inner model wall 29.
10. The inner core model 20 is removed directly in simple models
11. For complex models the inner core model 20 must be removed by dissolving it or by melting it or by splitting the model 2 with a blade along a seam and physically removing the inner core 20, in this case the model 2 can be resealed using a material specific adhesive. Dimensional measurement of model 2 wall thickness can be taken at this stage using calibrated equipment.
12. The model 2 is cleaned inside and out with Isopropyl Alcohol, or any suitable cleaning agent.
13. The reflective adhesive is now applied to the inner surface of the model 2, by any suitable means for example, using a brush, foam tipped stick or by spraying and allowed to cure for 24 hours before use.

The adjustable stand 5 facilitates adjustment of the position of the model 2 in the modeling system to simulate body posture. With reference to FIGS. 21 to 26 some possible orientations are illustrated.

The modelling system 1 may be used to model static and/or dynamic effects of blood flow and pressure on the blood vessel simulating model.

Also, as the introduction of an implant such as a stent, or stent graft will deliver additional stresses and strains into the vessel into which it is implanted, these stresses and strains are also modelled using the system of the invention with an implant device in place in the vessel simulating model 2.

In the embodiment described, the modelling system 1 is used to model the magnitude and direction of the resultant pulsative forces and stresses acting on the proximal and distal attachment mechanisms of a bifurcated graft X implanted inside the model 2 of an abdominal aorta.

Steps of the static testing method using the modelling system 1 include the following:
1. Connect model 2 to pump outlet 9, fill with water at 37 C and close model outlet valves 10
2. Activate pump 33, 34 and pressurize to desired pressure.
3. From the full field photo stress pattern areas of high/low stress can easily be observed
4. Quantitative stress/strain results can be derived by interpreting the fringe order and pattern
5. Similarly by implanting/placing a medical implant such as a stent/graft inside the model a different set of stress/strain results can be observed and calculated. Other possible test situations include simulating for example a balloon such as used on an angioplasty catheter may be inflated inside the model.
6. By varying the orientation of the model 2 to represent various body positions more valuable information about the resultant induced wall stresses/strains in the model 2 can be observed and calculated.

The dynamic testing method using the modelling system 1 includes the following further steps:
7. By cycling the pump under computer control in a manner similar to the heart and opening the model outlet control valves 10 to a suitable level, systemic blood pressure levels and periods can be replicated.
8. As in the static case above steps 3 through 6 can be performed and recorded using a camera 4 and analysed to yield dynamic stress/strain information in a dynamically functioning model.

While in the above example, tests are carried out by circulating water at 37 C the tests may also be done at room temperature.

The steps of the static and dynamic testing methods are the same for measurement of stresses and strains on a model whether or not an implant has been implanted into the model.

The steps of a method of analysing the test results include the following:
1] Results are analysed and compared for varying pressure, position and implant design in both static and dynamic conditions
2] Independent strain measurement is measured to confirm observed strains using the above methods
3] Comparative Computational Finite Element Analysis can be completed

### EXAMPLE 1

Referring to FIGS. 10 to 28 the results of testing a model 102 of the invention using the above described modelling system 1 and method are described. The model 102 is mounted in the modelling system 1. The model 102 is a model simulating an Abdominal Aorta Aneurysm (AAA) which as illustrated in FIG. 10 comprises a proximal end 103, an aneurysm sac 104 and two distal iliac legs 105 and 106. Images of portions of the AAA model 102, as acquired using a polariscope and camera, during testing are shown in FIGS. 11-13, 19, 20, 27a, and 28a.

The results are grouped in five main areas:
A. Null balance compensation and principle stress/strain direction To define fringe order and stress/strain sign and magnitude at a specific point in a highly stressed area on the proximal side of the aneurysm sac for AAA model 102 under 150 mmHG.
B. Stress/strain sign and magnitude measurement at a specific point at a highly stressed area on the distal (iliac) side of the aneurysm sac for the AAA model 102 under 150 mmHg.
C. Circumferential expansion of the AAA model 102 under 205 mmHG.
D. Results of static pressure test.
E. Results of dynamic pressure test.
   Null Balance Compensation

Null balance compensation is carried out to define the fringe order and stress/strain sign and magnitude at a specific point in a highly stressed area on the proximal side of the aneurysm sac for the model under 150 mmHg of internal static pressure. Referring to FIG. 11 a magnified image of the AAA model 102 shows high and low stress areas.

A point of interest was selected as shown. The isochromatic fringe passing through this point is a Green-Yellow colour. In order to define exactly what the fringe order is for the Green-Yellow fringe the null balance compensation method was used.

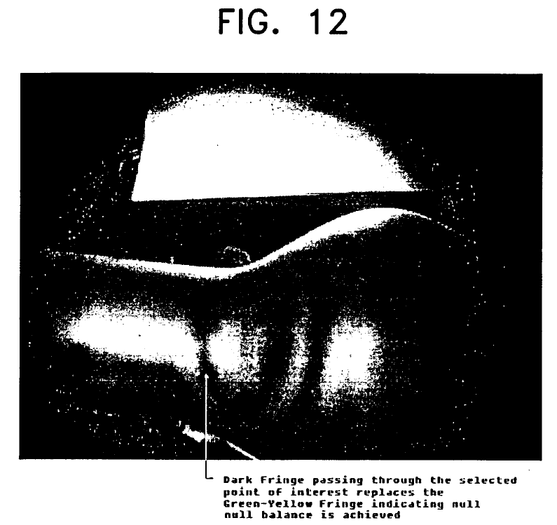

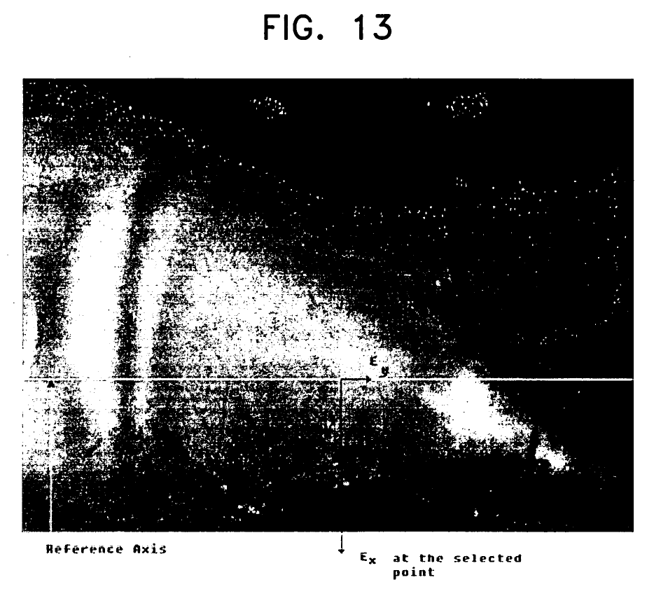

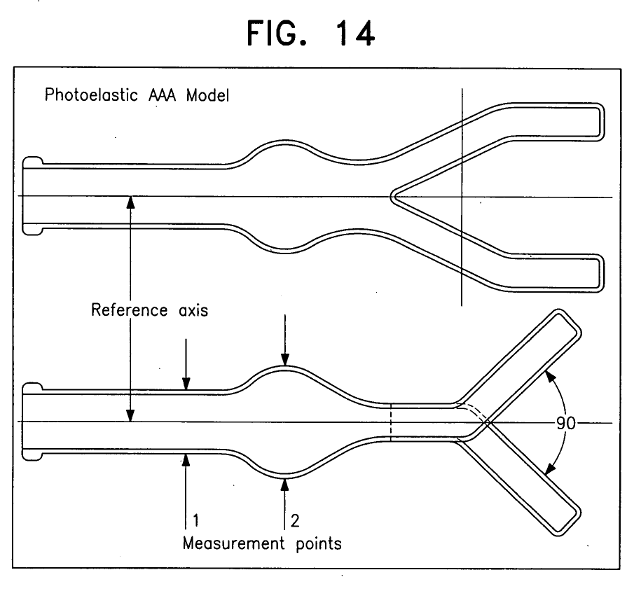

Null balance compensation was achieved as shown in FIG. 12. The Green-Yellow fringe was replaced with a black fringe indicating colour cancellation and null balance. At this point the reading from the Null Balance Compensator is read-off and plotted on a calibration chart.

Dial Reading=72 which from the calibration chart gives a value of N=1.3

Checking the Isochromatic Fringe Characteristics using standard calibration data the fringe order N=1.39 and has an associated fringe colour of Green-Yellow.

The principal stress/strain directions εₓ and ε_{y} were identified by observing the isoclinics, at the selected point of interest. It was found that the principal strain εₓ was approximately perpendicular to the reference axis (87 degrees with regard to the reference axis of the AAA model 102), thus the principal strain axis ε_{y} is approximately parallel to the reference axis as shown in FIG. 11.

It was also found that εₓ was much greater than ε_{y} and as such ε_{y} is assumed to be negligible when compared to εₓ thus,
σₓ=E/(1 +ν)·εₓ
and can be used to calculate the stress/strain magnitude.

where: εₓ=Nf
f=(λ/2tK)

Therefore, the stress magnitude at the selected point of interest on AAA model 102 is calculated as follows using:

The wavelength of tint
of passage in white light λ=575 nm
Green-Yellow fringe Order N=1.39

AAA wall thickness at the point
of interest t=0.0015 m
Young's Modulus of the model material E=14 MPa
Optical Coefficient K=0.006 (unit less)
Poisson ratio ν=0.42

Therefore,
f=(575×10⁻⁹)/2(0.0015×0.006)=31944 μm/m/fringe
σₓ=((14×10⁶)/(1.42))×(1.39×31944×10⁻⁶))Pa
σₓ=437768 Pa (0.438 MPa)
εₓ=44402 μstrain (4.44%)
   and the stress/strain direction is as shown in FIG. 11.
   Stress/Strain Direction and Magnitude Measurement at a Specific Point at a Highly Stressed Area on the Distal (Iliac) Aide of the Aneurysm Sac for the AAA Model 102 Under 150 mmHg

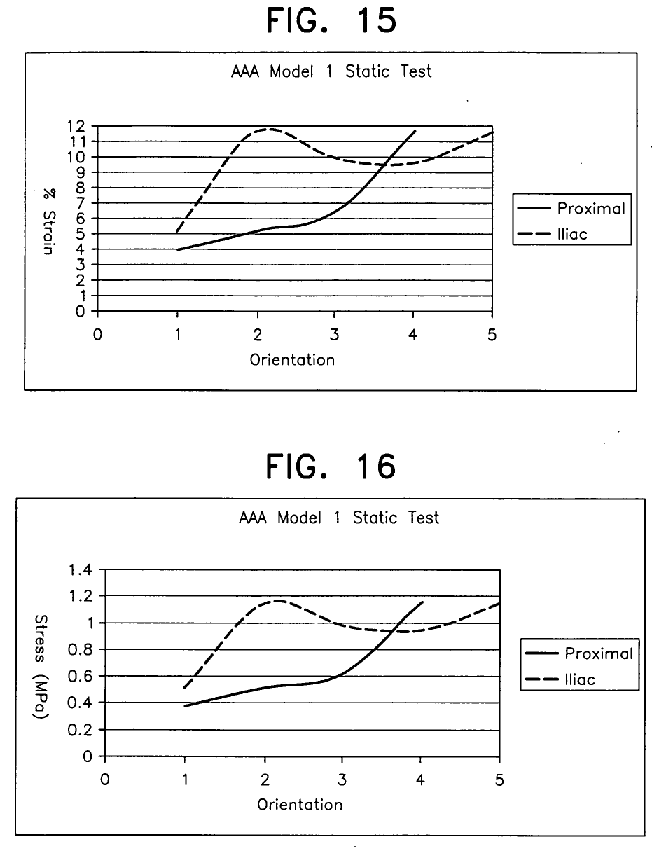

Referring to FIG. 13 a magnified image of an area of the model where high stress is evident (distal to the aneurysm sac 104 of FIG. 10) is shown. By observing the isoclinic lines, the principle strain direction εₓ at the selected point was found to approximately perpendicular to the reference axis. (87 degrees with regard to the reference axis of the AAA model 102), thus the principal strain axis ε_{y} is approximately parallel to the reference axis as shown in FIG. 13 (similar to the proximal case above). Again it was found that εₓ was much greater than ε_{y} and as such ε_{y} is assumed to be negligible when compared to εₓ

At a selected point on the model the strain/stress is calculated using the fringe order number associated with the colour fringe passing through the selected point.

Stress/Strain Magnitude at the Selected Point

The colour of the fringe passing through the selected point is orange and is a fractional order of N=1 i.e. its fringe value lies between 1 and 2 based on an understanding of the fringe pattern observed.
Fringe Order=1.63

Therefore, the above equation
f=(575×10⁻⁹)/2(0.0015×0.006)=31944 μm/m/fringe
σₓ=((14×10⁶)/(1.42))×(1.63×31944×10⁻⁶))Pa
σₓ=437768 Pa (0.513 MPa)
εₓ=52069 μstrain (5.21%)
   and the stress/strain direction is as shown in FIG. 13.
   Circumferential Expansion of the AAA Model 102

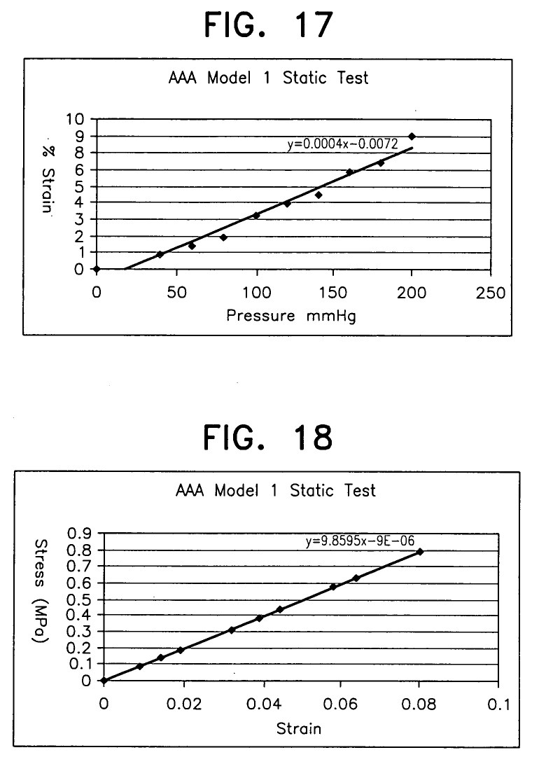

The circumferential expansion of the model under test was checked in two positions on the AAA model 102 as shown in FIG. 14 at 0 mmHg and at 150 mmHg by measuring the length of a thread tied on a slide knot around the model. This is at best an estimate.

TABLE 1
Results

| | Reading | Reading | Increase | % Increase |
|---|---|---|---|---|
| Pressure | 0 | 150 | 150 | N/A |
| MmHg | | | | |
| Measurement | 85.5 | 89 | 3.5 | 4.1 |
| Point 1 (mm) | | | | |
| Measurement | 164 | 170 | 4.0 | 3.75 |
| Point 2 (mm) | | | | |

Results of Static Pressure Test

Test result data obtained includes the following:
Internal static pressure (mmHg).
The AAA model 102 orientation as per FIGS. 21-26.
Position of interest on the model.
Estimated Stress Magnitude at the selected point (see FIGS. 11 and 13) based on the fringe order of the colour fringe passing through the selected point of interest.

Using the result data and based on stress and strain calculations for each fringe order, graphs of model 102 orientation versus strain and stress at the selected point of interest on the AAA model 102 were plotted as shown in FIGS. 15 and 16.

Results of Dynamic Pressure Test

Dynamic test data obtained includes data relating to the variation of stress and strain with pressure at a selected point on the AAA model 102.

Using the camera the fringe colour sitting over a selected point of interest (same point used in the static pressure test—proximal to the aneurysm sac) was recorded for various pressure readings starting at 200 mmHg and reducing in steps of 20 mmHg to zero. Using data on Isochromatic Fringe Characteristics based on stress and strain calculations the following graphs were drawn.

FIG. 17 shows the variation of % strain with pressure at a selected point of interest on the AAA model 102. FIG. 18 is a plot of stress versus strain at a selected point of interest on the AAA model 102.

Results—Full field Interpretation

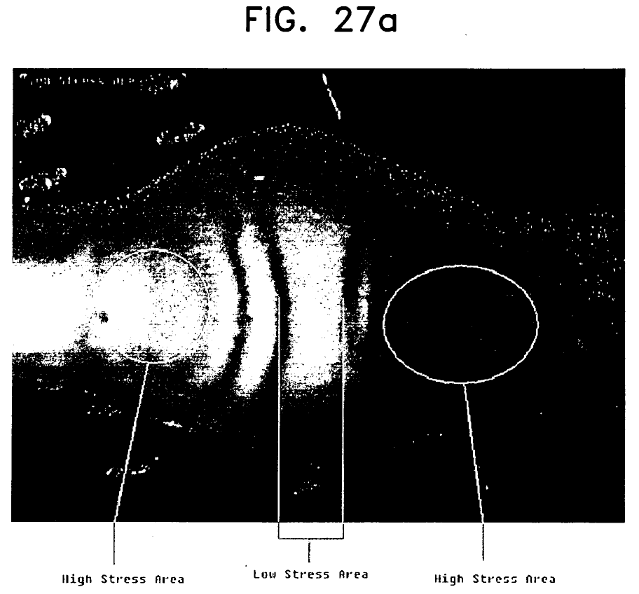

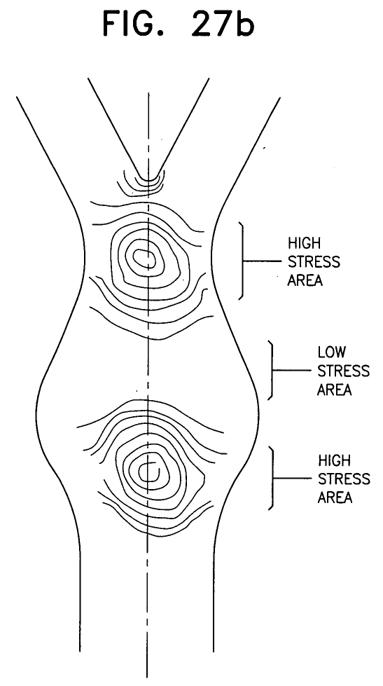

For both static and dynamic testing on AAA model 102 the results show two main areas of high stress concentration on the model. These areas are located proximal to the aneurysm sac and distal to the aneurysm sac (at the iliac bifurcation). The area in the center of the Aneurysm (greatest diameter) is a low stress area. FIGS. 27a and 27b show a full-field view of AAA model 102 indicating the high and low stressed regions.

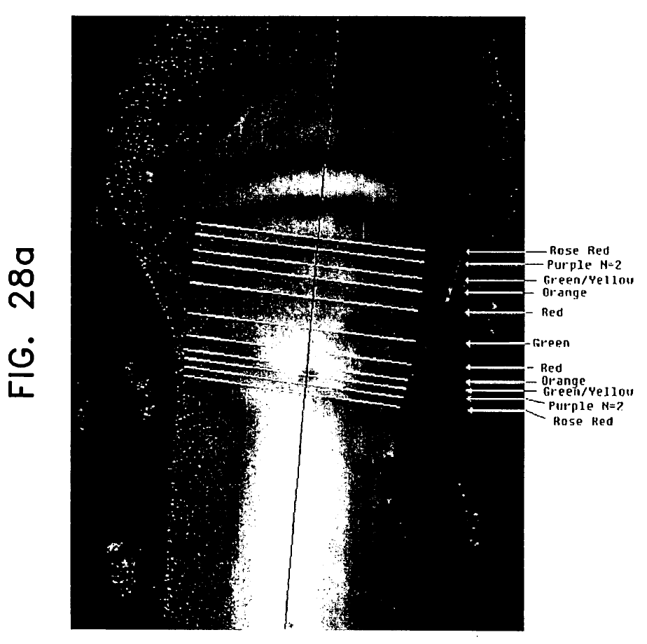

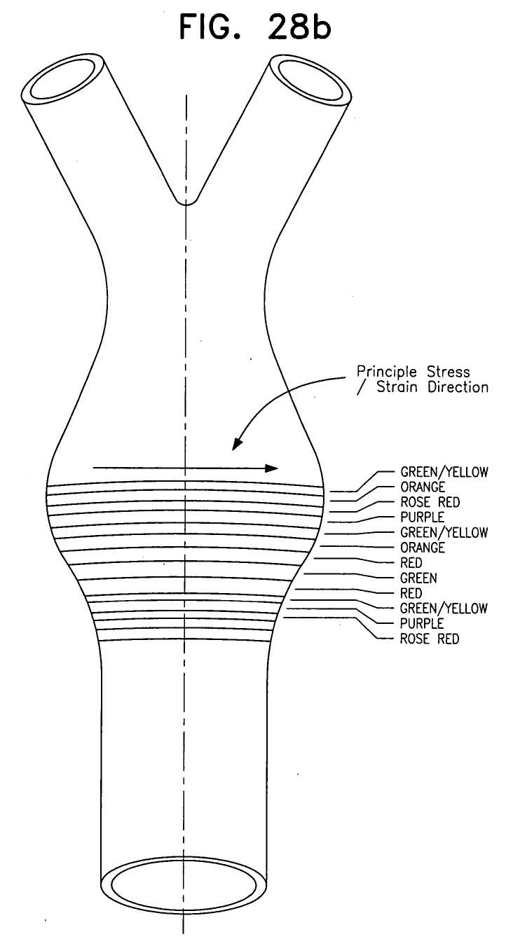

Focusing on the proximal area of AAA model 102 the photostress colour fringes seem to be centered on a point of maximum stress. This is an optical effect due to the fact that the model is symmetrically round. The fringes in fact go around the model in circumferential rings, the centers of which lie approximately on the reference axis as shown in FIG. 28. The black line passing through the center of the maximum stress is the plane along which the incident light is hitting the AAA model 102 at substantially 90 degrees to the surface. The parallel white lines passing through the fringes are tangents to the ring fringes (of the same colour) and indicate the direction of principal strain in this case.

Using an understanding of the fringe pattern the general stress magnitudes in the highly stressed area can easily be calculated. In FIG. 28 the maximum stress magnitude occurs at the center of the Green area and has a value of 0.976 MPa.

During dynamic testing the Full Field method can be used to view the effects of cyclic pressure on the AAA model 102 and estimate associated stress magnitudes.

Static Test Results AAA model 102

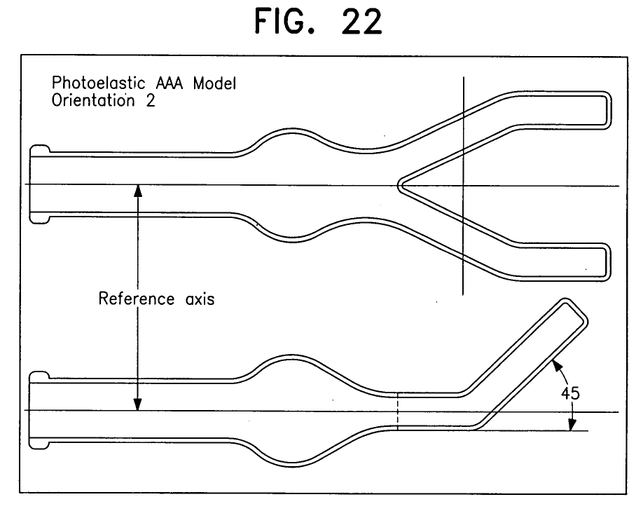

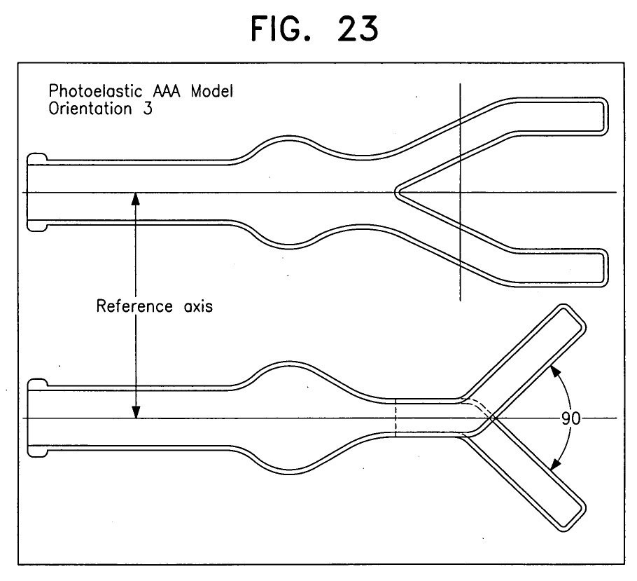

With reference to FIG. 15, on the Proximal side of the aneurysm sac, varying the iliac legs in orientations 2 and 3 (FIG. 22 and 23) increased the strain at the selected point of interest on the proximal side of the aneurysm sac by approximately 1% and 2% respectively from orientation 1 (normal—FIG. 21).

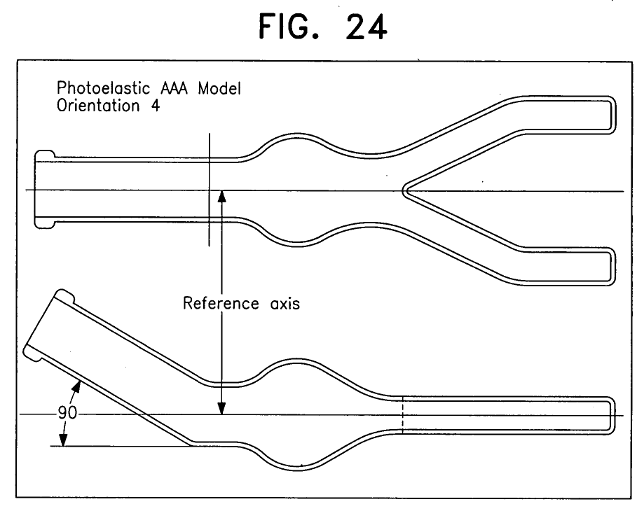

Bending the aneurysm neck proximal to the aneurysm sac at an angle of 30 degrees (orientation 4—FIG. 24) resulted in an increase of the strain at the selected point of interest of approximately 7.5% from orientation 1 (normal—FIG. 21).

On the Iliac side of the aneurysm sac, varying the iliac legs in orientations 2 and 3 (as shown in FIGS. 22 and 23) increased the strain at the selected point of interest on the iliac side of the aneurysm sac by approximately 7% and 4.5% respectively from orientation 1 (normal—FIG. 21).

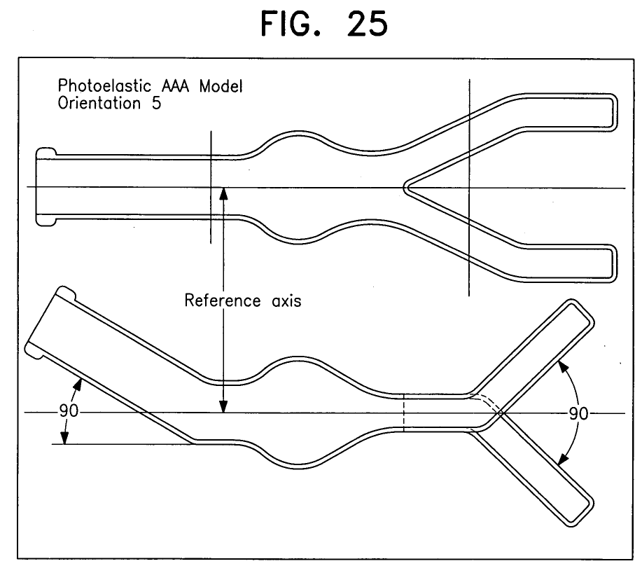

Varying the proximal leg angle (orientation 4—FIG. 24) increases the strain at the selected point of interest on the iliac side of the aneurysm sac by approximately 4.5% and while at the same time varying the iliac legs (orientation 5—FIG. 25) the strain increases by approximately 6.5% from orientation 1 (normal FIG. 21).

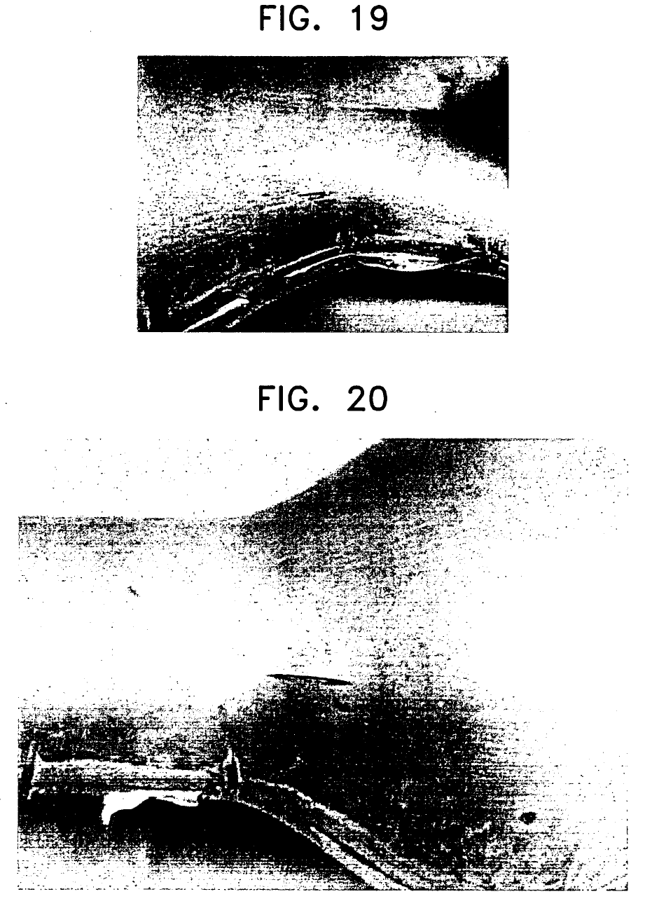

In all cases above varying the proximal and iliac legs significantly increases the strain (and stress) at a selected point of interest, which increases the risk of aneurysm rupture. Referring to FIGS. 19 and 20 there are illustrated images of models of the invention in which the wall of which burst under pressure. The rupture points are as predicted by the high stress areas observed in FIGS. 27a and 27b.

The strain at the selected point in FIG. 11 was found to be 4.44%. An independent estimated circumferential dimension checked at a location close to the selected point found an increase in strain of 4.1% (both tests were conducted at 150 mmHg on AAA model 102). This indicated that the photostress method is relatively accurate as both results are comparable.

Dynamic Test Results AAA Model 102

The variation of strain with internal pressure in AAA model 102 at a selected point of interest shows a linear relationship as shown in FIG. 17, which means that for a given pressure the strain at any point on a circle (centered on the reference axis) and passing through the selected point can be deducted.

Over the same pressure range the Stress versus Strain also shows a linear relationship and gave a Young's modulus for the material of approximately 10 MPa and is comparable to the typical value quoted in the material specification (Appendix A) 14 MPa, (after 1 minute strain).

Using the modelling system of the invention almost any vessel of interest in the body could be modelled and tested using the photostress method as detailed in this experiment. Test results can be produced very quickly.

The system and method provides data on the overall stress distribution in the blood vessel wall. It also provides information on areas of high and low stress in the vessel wall.

The photostress method has proven to be a very powerful tool in the stress analysis of the vessel simulating models producing results which are visual and easy to understand.

The data generated by the method of the invention may be fed back into the design engineering evaluation and improvement process.

The method of the invention is very flexible and versatile. The method may be used to model the effects of blood pressure and forces on any vessel. The system also provides means for simulating different body postures for purposes of modelling. Similarly by implanting/placing a medical implant such as a stent/graft inside the model a different set of stress/strain results can be observed and calculated. Other possible test situations include simulating for example a balloon such as used on an angioplasty catheter and which may be inflated inside the model.

The method provides results which are complementary to computation modelling approaches such as Finite Element Analysis (FEA). Results assist in the design process of the implantable devices under test and provide very valuable information on the effect of the implant on the vessel wall and best design anchorage mechanisms which should be employed. The results are of benefit in the design of effective implant anchorage and sealing mechanisms for implants.

The method of the invention provides results which are qualitative and quantitative.

The model of the invention is flexible and can be used in atmospheric pressure, and under variable static or dynamic pressure environments.

The modelling system of the invention is cost effective to set-up and install and is user friendly and easy to use.

It will be appreciated that while the embodiments described relate to simulation of blood vessels a similar model and method could be applied to model other body parts for example, digestive system, reproductive system, urinary system and respiratory system. In the embodiment described the model is connected to a blood flow simulation system which is described in more detail in References 7 and 8. It will however be appreciated that the model may be connected to any suitable blood flow simulation system. The complex model manufacture described above is described in more details in Reference 9.

The invention is not limited to the embodiments hereinbefore described which may be varied in detail.

APPENDIX A - Photoelastic Materials and Adhesives Specifications and Properties

Photoelastic Low-Modulus Materials

PL-3 Liquid

| | |
|---|---|
| StrainOptical Coeff. K | 0.006 (typical) |
| Elongation (%) | >50 |
| Elastic Modulus E | 2 (0.014) After one minute |
| 1000 psi (GPa) | of constant strain. |
| V | 0.42 |
| Thickness | For casting contourable sheets |
| | up to 0.125 in (3.2 mm) |
| Sensitivity Constant | 90 (32) |
| to deg F. (deg C.) | |
| Max Usable Temperature | 300 (150) |
| deg F. (deg C.) | |

PL-6 Liquid

| | |
|---|---|
| Strain Optical Coef. K | 0.001 (typical) |
| Elongation (%) | >100 |
| Elastic Modulus E | 0.1 (0.0007)After one minute |
| 1000 psi (GPa) | of constant strain. |
| V | 0.500 |
| Thickness | Sheet sizes: Quoted on request. |
| | Liquid: For casting contourable |
| | sheets up to 0.125 in (3.2 mm). |
| Sensitivity Constant to | 90 (32) |
| deg F. (deg C.) | |
| Max Usable Temperature | 300 (150) |
| deg F. (deg C.) | |

Photoelastic Low-Modulus Adhesives

PC-9 Adhesive: An extra-high-elongation material for use with PL6

| | |
|---|---|
| Cure Time (Hours) | 24 |
| Cure Temperature | Room |
| Elongation (%) | >100 |
| Elastic Modulus E 1000 psi (GPa) | 0.1 (0.0007) |
| Max Usable Temperature deg F. (deg C.) | 300 (150) |

PC-11 Adhesive: A high-elongation material formulated for
bonding contoured sheets prepared from PL3 liquid

| | |
|---|---|
| Cure Time (Hours) | 24 |
| CureTemperature | Room |
| Elongation (%) | >50 |
| Elastic Modulus E 1000 psi (GPa) | 1 (0.007) |
| Max Usable Temperature deg F. (deg C.) | 400 (200) |

1. A system for modelling forces and/or stresses and/or strains exerted on a body part, the system comprising:
a body part simulator configured with characteristics substantially similar to a body part being simulated;
the body part simulator comprising a photoelastic material;
an optical measuring system for optically measuring forces and/or stresses and/or strains exerted on the body part simulator; and
the measuring system comprising a polariscope.

2. A system as claimed in claim 1, wherein the body part simulator is formed by injection moulding.

3. A system as claimed in claim 2, wherein an inner surface of the body part simulator is bonded using a reflective adhesive to an inner surface liner comprised of a plastics, rubber, or polymer material in a tri-layer configuration.

4. A system as claimed in claim 1, wherein the body part simulator is formed by casting.

5. A system as claimed in claim 1, wherein the body part simulator comprises a plastics or rubber or polymer material.

6. A system as claimed in claim 1, wherein the photoelastic material has a modulus of greater than 0.4 Mpa.

7. A system as claimed in claim 6, wherein the photoelastic material has a modulus in the range of from 0.5 Mpa to 2900 Mpa.

8. A system as claimed in claim 1, wherein an inner surface of the body part simulator is coated with a reflective adhesive.

9. A system as claimed in claim 1, wherein the body part simulator is mounted on an adjustable support.

10. A system as claimed in claim 9, wherein the support is adjustable to adjust the orientation of the body part simulator to a desired angle for modelling of forces and/or stresses and/or strains exerted on the body part simulator at different body postures, such as upright, sitting, lying down.

11. A system as claimed in claim 1, wherein the body part simulator comprises an abnormality simulator portion configured to simulate an abnormality, such as an aneurysm or stenosis.

12. A system as claimed in claim 1, wherein an implant is insertable into the body part simulator to model forces and/or stresses and/or strains resulting from insertion of the implant.

13. A system as claimed in claim 1, wherein the system comprises an implant insertable into the body part simulator.

14. A system as claimed in claim 13, wherein the implant is a stent, or stent graft, or filter, or sensor, or angioplasty catheter, or delivery catheter, or delivery system, or retrieval catheter.

15. A system as claimed in claim 1, wherein the body part simulator comprises a blood vessel(s) simulator configured with characteristics substantially similar to a blood vessel(s) being simulated.

16. A system as claimed in claim 1, wherein the body part simulator comprises a hollow vessel simulator of the urinary system configured with characteristics substantially similar to the hollow vessel being simulated.

17. A system as claimed in claim 1, wherein the body part simulator comprises a hollow vessel simulator of the digestive system configured with characteristics substantially similar to the hollow vessel being simulated.

18. A system as claimed in claim 1, wherein the body part simulator comprises a hollow vessel simulator of the reproductive system configured with characteristics substantially similar to the hollow vessel being simulated.

19. A system as claimed in claim 1, wherein the body part simulator comprises a hollow vessel simulator of the respiratory system configured with characteristics substantially similar to the hollow vessel being simulated.

20. A system as claimed in claim 1, wherein the system comprises a body fluid simulator in fluid communication with the body part simulator.

21. A system as claimed in claim 1, wherein the body fluid simulator comprises a blood simulator.

22. A system as claimed in claim 21, wherein the system comprises a fluid circulation system for circulating the body fluid simulator.

23. A system as claimed in claim 21, wherein the fluid circulation system comprises a pump, a fluid reservoir, and a controller.

24. A system as claimed in claim 21, wherein the body part simulator is connected in fluid communication with the fluid circulation system by one or more valve connectors.

25. A system as claimed in claim 1, wherein the optical measuring system comprises a video and/or a still camera.

26. A modelling system comprising a blood vessel simulating model connected to a blood flow simulation system for modelling the forces and/or stresses and/or strains of blood flow and blood pressure on the blood vessel.

27. A method of modelling the stresses and strains of pulsative forces on a blood vessel comprising the steps of:
manufacturing a blood vessel simulating model according to specifications of the vessel to be simulated;
mounting the model in a modelling system on an adjustable stand and connected to a liquid circulation system;
circulating liquid into the model;
varying the pressure exerted on the model by the liquid;
varying the orientation of the model; and
acquiring stress and strain data of the model under different pressure and at different orientations using a polariscope system.
